(19) United States
(12) Patent Application Publication
(10) Pub. No.: US 2013/0100516 A1
(43) Pub. Date: Apr. 25, 2013

(54) ELECTRO WETTING DISPLAY

(71) Applicants: Gi Heon Kim, Daejeon (KR); Sang Hee Park, Daejeon (KR)

(72) Inventors: Gi Heon Kim, Daejeon (KR); Sang Hee Park, Daejeon (KR)

(73) Assignee: ELECTRONICS AND TELECOMMUNICATIONS RESEARCH INSTITUTE, Daejeon (KR)

(21) Appl. No.: 13/493,498

(22) Filed: Jun. 11, 2012

(30) Foreign Application Priority Data
Oct. 19, 2011 (KR) 10-2011-0106782

(51) Int. Cl. G02B 26/02

(52) U.S. Cl. 359/228

(57) ABSTRACT

Provided is an electro wetting display capable of improving driving stability by more stably controlling movement of a nonpolar fluid among electro wetting elements. The electro wetting display according to an exemplary embodiment of the present disclosure includes: a first substrate formed on a viewing side of the display, a second substrate formed on a rear side of the display, a pixel partition wall formed between the first and second substrates to partition a pixel area, in which a part of the partition wall is made of a conductive material, and a polar fluid and a nonpolar fluid filled in the pixel area partitioned by the pixel partition wall.

### CROSS-REFERENCE TO RELATED APPLICATIONS

This application is based on and claims priority from Korean Patent Application No. 10-2011-0106782, filed on Oct. 19, 2011, with the Korean Intellectual Property Office, the disclosure of which is incorporated herein in its entirety by reference.

### TECHNICAL FIELD

The present disclosure relates to an electro wetting display for implementing a pixel by using an electro wetting element.

### BACKGROUND

An electro wetting display includes an electro wetting element which reversibly controls transmission and absorption of external light by applying an electric field between two sheets of support substrates (generally, glass substrates). The electro wetting element includes a polar fluid (mainly, water or salt water) having high permeability and a colored (mainly, black) nonpolar fluid, and a position of the polar fluid is controlled so as to transmit or absorb the light. The electro wetting display has excellent brightness and a contrast ratio and has relatively low power consumption.

FIGS. 1 and 2 are a plan view and a cross-sectional view of a general electro wetting display.

Referring to FIGS. 1 and 2, the general electro wetting display has a viewing side and a rear side, and includes a plurality of electro wetting elements between a first support substrate 101 formed on the viewing side and a second support substrate 103 formed on the rear side. In particular, the general electro wetting display includes a first conductive thin film 105 formed below the first support substrate 101, a second conductive thin film 107 formed above the second support substrate 103, an insulating thin film 109, a hydrophobic insulator thin film 111, and a pixel partition wall 113 formed between the first conductive thin film 105 and the hydrophobic insulator thin film 111. A polar fluid 115 and a nonpolar fluid 117 which do not have miscibility to each other are filled in a pixel area partitioned by the pixel partition wall 113.

When voltage is applied to the display, the colored nonpolar fluid 117 disposed on the hydrophobic insulator thin film 111 is contracted in one corner of the pixel partition wall 113 or divided into small-sized particles or a mass, and the polar fluid 115 is contacted with the hydrophobic insulator thin film 111.

When the light passes through the electro wetting element, the light is absorbed through the nonpolar fluid 117, but the light is transmitted through the polar fluid 115 as it is. As described above, the electro wetting display implements a pixel and an image by reversibly controlling the position and area of the nonpolar fluid 117 according to application of the electric field. In this case, a shift speed of absorption and transmission modes of the light is the most important factor for determining a response speed and an image characteristic of the electro wetting display.

Accordingly, during driving of the electro wetting display, moving direction and speed of the colored nonpolar fluid 117 and an amount (thickness) of the nonpolar fluid 117 in the pixel area need to be stably controlled.

### SUMMARY

The present disclosure has been made in an effort to provide an electro wetting display capable of improving driving stability by more stably controlling movement of a nonpolar fluid among electro wetting elements.

An exemplary embodiment of the present disclosure provides an electro wetting display, including: a first substrate formed on a viewing side of the display; a second substrate formed on a rear side of the display; a pixel partition wall formed between the first and second substrates to partition a pixel area, in which a part of the partition wall is made of a conductive material; and a polar fluid and a nonpolar fluid filled in the pixel area partitioned by the pixel partition wall.

An electric field may be applied to the part of partition wall made of the conductive material of the pixel partition wall to control movement of the polar fluid and the nonpolar fluid.

The first substrate includes a first support substrate and a first conductive thin film formed below the first support substrate, and the second substrate includes a second support substrate, a second conductive thin film formed above the second support substrate, an insulation thin film formed above the second conductive thin film and a hydrophobic insulator thin film formed above the insulation thin film, in which the electric field is applied to the first and second conductive thin films to control movement of the polar fluid and the nonpolar fluid.

Another exemplary embodiment of the present disclosure provides an electro wetting display, including: a first substrate formed on a viewing side of the display; a hydrophilic thin film formed below the first substrate; a second substrate formed on a rear side of the display; a pixel partition wall formed between the hydrophilic thin film and the second substrates to partition a pixel area, in which a part of the partition wall is made of a conductive material; and a polar fluid and a nonpolar fluid filled in the pixel area partitioned by the pixel partition wall.

According to the exemplary embodiments of the present disclosure, movement direction and speed of a nonpolar fluid can be stably controlled without requiring a separate surface treatment or a thin film patterning process by forming a part of a pixel partition wall of an electro wetting display with a conductive material, thereby ensuring driving stability.

An amount (thickness) of the nonpolar fluid can be more stably controlled by forming a hydrophilic thin film made of thermal/photo curing hydrophilic polymers below a substrate of a viewing side and/or on a pixel partition wall.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1 and 2 are a plan view and a cross-sectional view of a general electro wetting display.

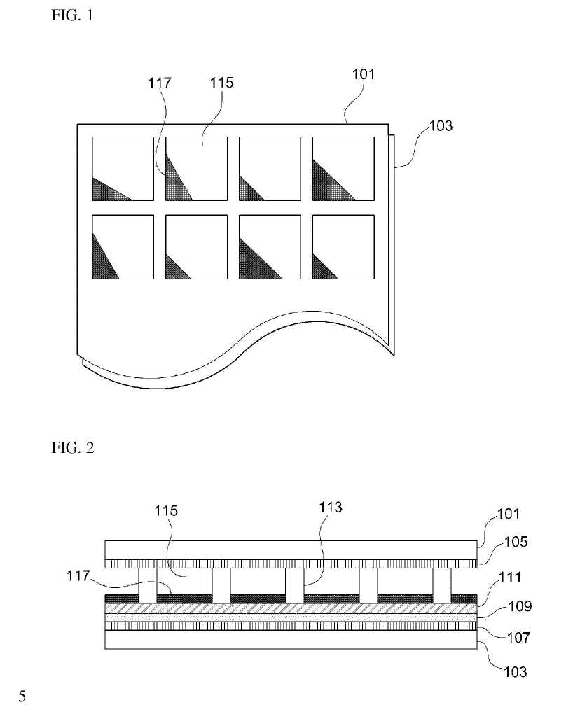

FIGS. 3 and 4 are a plan view and a cross-sectional view of an electro wetting display according to an exemplary embodiment of the present disclosure.

FIG. 5 is a cross-sectional view of an electro wetting display according to another exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

The aforementioned objects, features, and advantages will be described in detail with reference to the accompanying drawings, and as a result, the spirit of the present disclosure will be able to be easily implemented by those skilled in the art. In describing the present disclosure, well-known constructions or functions will not be described in detail when it is judged that they may unnecessarily obscure the understanding of the present disclosure. Hereinafter, exemplary embodiments of the present disclosure will be described in detail with reference to the accompanying drawings.

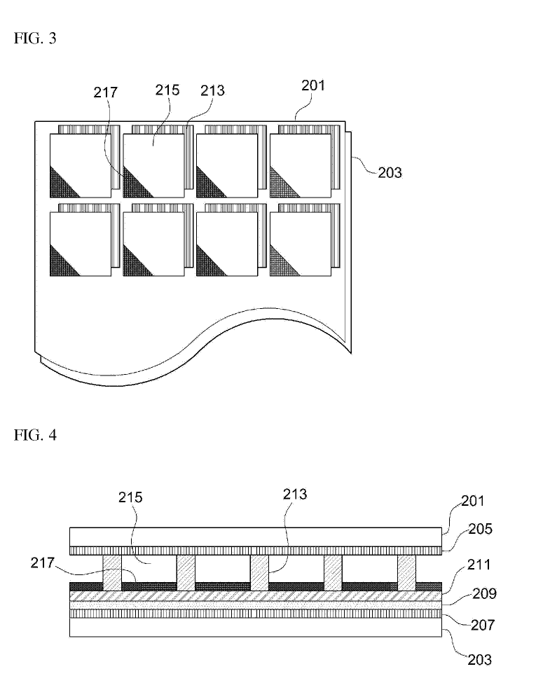

FIGS. 3 and 4 are a plan view and a cross-sectional view of an electro wetting display according to an exemplary embodiment of the present disclosure.

Referring to FIGS. 3 and 4, an electro wetting display according to an exemplary embodiment of the present disclosure includes a first substrate formed on a viewing side of the display, a second substrate formed on a rear side of the display, a pixel partition wall 213 formed between the first and second substrates to partition a pixel area, in which a part of the partition wall is made of a conductive material, and a polar fluid 215 and a nonpolar fluid 217 filled in the pixel area partitioned by the pixel partition wall 213.

Herein, the first substrate includes a first support substrate 201 and a first conductive thin film 205 formed below the first support substrate 201, and the second substrate includes a second support substrate 203, a second conductive thin film 207 formed above the second support substrate 203, an insulation thin film 209 above the second conductive thin film 207 and a hydrophobic insulator thin film 211 formed above the insulation thin film 209.

Since the electro wetting display implements an image by electrically controlling contraction/relaxation of the nonpolar fluid 217, the flow of the nonpolar fluid 217 is required to be controlled for each pixel, and as a result, pixels are partitioned by partition walls. In the case, the partition wall generally has a height of 2 μm to 50 μm and is formed by using a lithography process.

In the exemplary embodiment of the present disclosure, a conductive partition wall is formed by adding a conductive material into a part of the pixel partition wall 213 formed on the hydrophobic insulator thin film 211, instead of a separate surface treatment of the hydrophobic insulator thin film 211 or a patterning process of the conductive thin films 205 and 207, in order to control contraction direction and contraction/relaxation speed of the nonpolar fluid 217. As described above, a moving direction of the nonpolar fluid 217 may be controlled during application of the electric field by conducting the part of the pixel partition wall 213. That is, when the electric field is applied to the conductive thin films 205 and 207, the polar fluid 215 is first absorbed onto the conductive partition wall and then moves to the surface of the hydrophobic insulator thin film 211, thereby controlling the moving direction of the nonpolar fluid 217. In this case, a shape and a height of the formed conductive partition wall may be variously applied according to a range of applications or an object.

In a method of forming the pixel partition wall 213, first, in the case of the conductive partition wall, a conductive photoreactive composition having a thickness of 2 to 50 micrometers (μm) may be formed on the surface of the hydrophobic insulator thin film 211 by using a photomask through the lithography process in consideration of the moving direction of the nonpolar fluid 217, in which the conductive photoreactive composition is acquired by mixing nano-sized conductive particles (indium tin oxide (ITO), indium zinc oxide (IZO), carbon nanotube (CNT), graphene, metals (Au, Ag, Cu, Pt) and the like) of a weight ratio of 1 to 50% into a photoreative composition (constituted with a photo initiator, a reactive acrylate monomer or oligomer, an adhesion reagent, a solvent, and a surfactant) in consideration of a conductive characteristic. Subsequently, a non-conductive partition wall is formed with a photoreactive composition in which the conductive material is not mixed, by using a general lithography process. As described above, the pixel partition wall 213 is divided into a conductive partition wall and a nonconductive partition wall, and may be formed in a closed type or an open type in combination thereof according to a range of applications or an object.

The first and second conductive thin films 205 and 207 have high transmission to light, and the ITO, IZO, carbon nanotube, graphene, metals (Au, Ag, Cu, Pt) and the like may be used either alone or in combination thereof.

The insulation thin film 209 for insulation between the pixels is formed above the second conductive thin film 207, and in the insulation thin film 209, organic or inorganic materials may be formed either alone or in a multi layer.

The hydrophobic insulator thin film 211 having an interfacial characteristic similar to the nonpolar fluid 217 is formed above the insulation thin film 209. In a state where voltage is not applied, the nonpolar fluid 217 covers the surface of the hydrophobic insulator thin film 211, but when the voltage is applied, the nonpolar fluid 217 is contracted, and the polar fluid 215 having conductivity moves to the surface of the hydrophobic insulator thin film 211, thereby implementing a transmission characteristic of light.

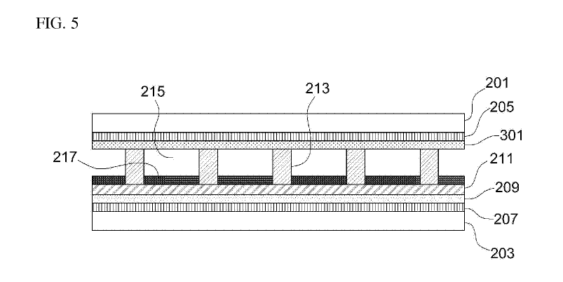

FIG. 5 is a cross-sectional view of an electro wetting display according to another exemplary embodiment of the present disclosure.

Referring to FIG. 5, an electro wetting display according to another exemplary embodiment of the present disclosure further includes a hydrophilic thin film 301 in addition to the configuration shown in FIGS. 3 and 4.

In the exemplary embodiment, in order to properly control the amount (thickness) of the nonpolar fluid 217, the hydrophilic thin film 301 is further formed below the first conductive thin film 205 in the range of 30 to 150 nm so as not to affect a driving characteristic of the conductive partition wall or the first and second conductive thin films 205 and 207. As a result, while the nonpolar fluid 217 is contracted and relaxed by an electric field, the nonpolar fluid 217 disposed on the second conductive thin film 207 is adhered to the first conductive thin film 205 to avoid losing a dynamic behavior characteristic due to the electric field, thereby more improving driving stability of the nonpolar fluid 217.

Herein, the used hydrophilic thin film 301 is a polymer thin film including poly(vinyl alcohol), poly(vinyl acetate), poly(vinyl pyrrolidone), cellulose and polyacrylate or at least one or more thereof, and is formed by adding and curing a photo initiator or a thermal initiator into a reactive monomer and a reactive oligomer, thereby ensuring process stability.

In this case, examples of the photo initiator may include 1-hydroxy-cyclohexyl-phenyl-ketone, (Irgacure 907), 2-methyl-1[4-(methylthio)phenyl]-2-morpholinopropane-1-one (Irgacure 184C), 2-hydroxy-2-methyl-1-phenyl-propane-1-one (Darocur 1173), a mixed initiator (Irgacure 500) of Irgacure 184C of 50 wt % and benzophenone of 50 wt %, a mixed initiator (Irgacure 1000) of Irgacure 184 of 20 wt % and Irgacure 1173 of 80 wt %, 2-hydroxy-1-[4-(2-hydroxyethoxy)phenyl]-2-methyl-lpropanone (Irgacure 2959), methylbenzoylformate (Darocur MBF), alpha, alpha-dimethoxy-alpha-phenylacetophenone (Irgacure 651), 2-benzyl-2-(dimethylamino)-1-[4-(4-morpholinyl)phenyl]-1-butanone (Irgacure 369), a mixed initiator of Irgacure 369 of 30 wt % and Irgacure 651 of 70 wt % (Irgacure 1300), diphenyl(2,4,6-trimethylbenzoyl)-phosphine oxide (Darocur TPO), a mixed initiator of Darocur TPO of 50 wt % and Darocur 1173 of 50 wt % (Darocur 4265), phosphine oxide, phenyl bis(2,4,6-trimethyl benzoyl) (Irgacure 819), a mixed initiator of Irgacure 819 of 5 wt % and Darocur 1173 of 95 wt % (Irgacure 2005), a mixed initiator of Irgacure 819 of 10 wt % and Darocur 1173 of 90 wt % (Irgacure 2010), a mixed initiator of Irgacure 819 of 20 wt % and Darocur 1173 of 80 wt % (Irgacure 2020), bis(.eta.5-2,4-cyclopentadien-1-yl)bis[2,6-difluoro-3-(1H-pyrrol-1-yl)phenyl]titanium (Irgacure 784), and a mixed initiator (HSP 188) containing benzophenone.

Examples of the thermal initiator may include benzoyl peroxide (BP), acetyl peroxide (AP), diauryl peroxide (DP), di-tert-butyl peroxide (t-BTP), cumyl hydroperoxide (CHP), hydrogen peroxide (HP), potassium peroxide (PP), 2,2′-azobisisobutyronitrile (AIBN), and an azo compound.

Examples of an initiator using a silver alkyls oxidation-reduction reaction may include persulfate (K₂S₂O₈) and a redox initiator.

The hydrophilic thin film 301 may also be coated on the pixel partition wall 213 to be used in order to prevent the nonpolar fluid 217 from moving to another pixel beyond the partition wall during driving. Deep coating, spin coating, bar coating and the like may be used as a method of coating the hydrophilic thin film 301 on the partition wall.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An electro wetting display, comprising:
a first substrate formed on a viewing side of the display;
a second substrate formed on a rear side of the display;
a pixel partition wall formed between the first and second substrates to partition a pixel area, in which a part of the partition wall is made of a conductive material; and
a polar fluid and a nonpolar fluid filled in the pixel area partitioned by the pixel partition wall.

2. The electro wetting display of claim 1, wherein an electric field is applied to the part of partition wall made of the conductive material of the pixel partition wall to control movement of the polar fluid and the nonpolar fluid.

3. The electro wetting display of claim 1, wherein the part of partition wall made of the conductive material of the pixel partition wall is formed with a conductive photoreactive composition having a thickness of 2 to 50 micrometers which is acquired by mixing nano-sized conductive particles of a weight ratio of 1 to 50% in a photoreactive composition.

4. The electro wetting display of claim 1, wherein
the first substrate includes a first support substrate; and a first conductive thin film formed below the first support substrate, and
the second substrate includes a second support substrate; and a second conductive thin film formed above the second support substrate; an insulation thin film formed above the second conductive thin film; and a hydrophobic insulator thin film formed above the insulation thin film,
wherein the electric field is applied to the first and second conductive thin films to control movement of the polar fluid and the nonpolar fluid.

5. The electro wetting display of claim 1, wherein the polar fluid is a high transmissive fluid transmitting light, and the nonpolar fluid is a colored fluid absorbing light.

6. An electro wetting display, comprising:
a first substrate formed on a viewing side of the display;
a hydrophilic thin film formed below the first substrate;
a second substrate formed on a rear side of the display;
a pixel partition wall formed between the hydrophilic thin film and the second substrates to partition a pixel area, in which a part of the partition wall is made of a conductive material; and
a polar fluid and a nonpolar fluid filled in the pixel area partitioned by the pixel partition wall.

7. The electro wetting display of claim 6, wherein the hydrophilic thin film is formed with a thickness of 30 to 150 nm by adding a photo initiator or a thermal initiator into a reactive monomer and a reactive oligomer.

8. The electro wetting display of claim 6, wherein an electric field is applied to the part of partition wall made of the conductive material of the pixel partition wall to control movement of the nonpolar fluid.

9. The electro wetting display of claim 6, wherein
the first substrate includes a first support substrate; and a first conductive thin film formed below the first support substrate, and
the second substrate includes a second support substrate; and a second conductive thin film formed above the second support substrate; an insulation thin film formed above the second conductive thin film; and a hydrophobic insulator thin film formed above the insulation thin film,
wherein the electric field is applied to the first and second conductive thin films to control movement of the nonpolar fluid.

10. The electro wetting display of claim 6, wherein the polar fluid is a high transmissive fluid transmitting light, and the nonpolar fluid is a colored fluid absorbing the light.
